(19) United States
(12) Patent Application Publication
(10) Pub. No.: US 2024/0318880 A1
(43) Pub. Date: Sep. 26, 2024

(54) COMPRESSOR COOLING SYSTEMS AND METHODS INCLUDING COOLANT DAMPING CHAMBER

(71) Applicant: Emerson Climate Technologies, Inc., Sidney, OH (US)

(72) Inventors: Michael M. Perevozchikov, Tipp City, OH (US); Patrick Shawn O'Meara, Tipp City, OH (US)

(21) Appl. No.: 18/186,386

(22) Filed: Mar. 20, 2023

(51) Int. Cl. F25B 31/00; F04D 17/10; F04D 29/42; F04D 29/58; F04D 29/66; F25B 5/02; F25B 41/42; F25B 43/00

(52) U.S. Cl. CPC F25B 31/008; F04D 17/10; F04D 29/4206; F04D 29/582; F04D 29/668; F25B 5/02; F25B 41/42; F25B 43/006

(57) ABSTRACT

A refrigeration system includes a compressor, an evaporator connected to a low pressure line of the compressor, a condenser, an expansion device, and a cooling circuit. The cooling circuit includes at least one coolant supply line to channel a coolant towards the compressor, at least one coolant flow channel defined by a housing of the compressor that channels the coolant towards a motor of the compressor, a coolant return line to channel the coolant towards the low pressure line of the compressor, and a damping chamber located between the coolant return line and the low pressure line of the compressor. The damping chamber includes a damping chamber inlet to allow the coolant to enter a damping chamber volume from the coolant return line and damping chamber outlets to allow the coolant in the damping chamber volume to enter the low pressure line of the compressor.

### FIELD

The field of the disclosure relates generally to refrigeration systems, and more particularly, to providing cooling to a compressor within a refrigeration system using a refrigerant drawn from a high pressure side of the refrigeration system.

### BACKGROUND

Dynamic compressors, including centrifugal compressors, are commonly used in process industries and in heating, ventilation, and air conditioning (HVAC) systems. The compressor is typically connected to a motor via a shaft that supports multiple compression stages. A drive controls the motor to rotate the compression stages at a rotational speed and loading condition selected to compress a refrigerant to a specified demand. The motor speed and load may be controlled to operate the compressor under a wide range of operating conditions.

During operation, the drive, motor, and compressor bearings may reach high temperatures that, if left unaddressed, may increase the risk of mechanical failure due to overheating. Existing cooling systems may divert relatively low temperature refrigerant from the main refrigeration circuit for use as a coolant for cooling components of the compressor. The coolant is channeled through a housing of the compressor where it provides cooling to the components of the compressor. The coolant is then channeled towards a low pressure side of the compressor where the coolant mixes with low pressure refrigerant entering the compressor via a suction line of the main refrigeration circuit. The low pressure refrigerant and the coolant are channeled through the compression stages and simultaneously compressed.

In some known systems, the coolant is diverted from a high pressure side of the main refrigeration circuit (e.g., from a portion between a condenser and an expansion valve). Using refrigerant drawn from the high pressure side of the main refrigeration circuit as the coolant creates the opportunity for disturbing the flow of low pressure refrigerant that enters the low pressure side of the compressor via the main refrigeration circuit. This may degrade the performance, efficiency, and/or longevity of the compressor. Thus, there is a need for a compressor system that facilitates using coolant drawn from a high pressure side of a refrigeration system for cooling the compressor while also facilitating reducing or eliminating the opportunity for the coolant to disturb the flow of refrigerant at the low pressure side of the compressor.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect is a refrigeration system that includes a compressor, an evaporator, a condenser, an expansion device, and a cooling circuit. The compressor includes a housing, a shaft rotatably supported in the housing, an impeller connected to the shaft, and a motor operably connected to the shaft. The evaporator is connected to a low pressure line of the compressor. The cooling circuit includes at least one coolant supply line to channel a coolant from one of the condenser and a refrigerant line connected between the condenser and the expansion device towards the housing, at least one coolant flow channel defined by the housing that receives the coolant from the at least one coolant supply line and channels the coolant towards the motor, a coolant return line to channel the coolant from the at least one coolant flow channel towards the low pressure line of the compressor, and a damping chamber located between the coolant return line and the low pressure line of the compressor. The damping chamber includes a damping chamber inlet connected to the coolant return line to allow the coolant to enter a damping chamber volume from the coolant return line, and damping chamber outlets connected to the low pressure line of the compressor to allow the coolant in the damping chamber volume to enter the low pressure line of the compressor.

Another aspect is a compressor system that includes a compressor and a cooling circuit. The compressor includes a housing defining a compressor inlet, a shaft rotatably supported in the housing, an impeller connected to the shaft, and a motor operably connected to the shaft. The housing has a passage extending between the compressor inlet and the impeller. The cooling circuit includes at least one coolant flow channel defined by the housing to receive a coolant and channel the coolant towards the motor, a coolant return line to channel the coolant from the at least one coolant flow channel towards the passage, and a damping chamber located between the coolant return line and the passage. The damping chamber includes a damping chamber inlet connected to the coolant return line to allow the coolant to enter a damping chamber volume from the coolant return line, and damping chamber outlets connected to the passage to allow the coolant in the damping chamber volume to enter the passage at discrete angular flow directions.

Another aspect is a method of operating a refrigeration system. The refrigeration system includes a compressor, an evaporator, a condenser, and an expansion device. The compressor includes a housing, a shaft rotatably supported in the housing, an impeller connected to the shaft, and a motor operably connected to the shaft. The method includes compressing a refrigerant using the compressor to produce compressed refrigerant, condensing the compressed refrigerant using the condenser to produce compressed, condensed refrigerant, expanding a first portion of the compressed, condensed refrigerant using the expansion device to produce uncompressed, condensed refrigerant, vaporizing the uncompressed, condensed refrigerant using the evaporator to produce uncompressed, vapor refrigerant, and channeling the uncompressed, vapor refrigerant towards a low pressure line of the compressor. The method also includes diverting a second portion of the compressed, condensed refrigerant towards the housing of the compressor to provide cooling to the motor, channeling the second portion of the compressed, condensed refrigerant towards the low pressure line of the compressor, and mixing the second portion of the compressed, condensed refrigerant with the uncompressed, vapor refrigerant within the low pressure line of the compressor. Mixing the second portion of the compressed, condensed refrigerant and the uncompressed, vapor refrigerant within the low pressure line of the compressor includes intersecting the uncompressed, vapor refrigerant with the second portion of the compressed, condensed refrigerant at discrete angular flow directions within the low pressure line.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

The following figures illustrate various aspects of the disclosure.

FIG. 1 is a schematic diagram of an example refrigeration system.

FIG. 2 is a schematic diagram of an example compressor system for use with the example refrigeration system shown in FIG. 1.

FIG. 3 is a perspective view of an example compressor for use in the refrigeration system shown in FIG. 1 and the compressor system shown in FIG. 2.

FIG. 4 is a cross section of the compressor shown in FIG. 3 taken along line 3-3.

FIG. 5 is a cross section of another example compressor for use in the refrigeration system shown in FIG. 1 and the compressor system shown in FIG. 2.

FIG. 6 is an enlarged view of a portion of the compressor shown in FIG. 5, indicated by Section C₄₀₀.

FIG. 7 is an exploded view of an example inlet guide vane apparatus for use in the compressor shown in FIG. 5.

Corresponding reference characters indicate corresponding parts throughout the drawings.

### DETAILED DESCRIPTION

Examples are described with respect to a centrifugal compressor but may be applicable to other types of compressors. The bearings, motor, and drive of a dynamic compressor may be cooled using a coolant. The coolant is drawn from a high pressure side of a main refrigeration circuit (e.g., a refrigeration loop used in a heating, ventilation, and air conditioning (HVAC) system). The coolant is channeled from the high pressure side of the main refrigeration circuit towards and through a housing of the compressor to provide cooling to components housed therein. The coolant is then channeled into a damping chamber prior to entering a low pressure line of the compressor. The damping chamber includes a damping chamber inlet that allows the coolant to enter a damping chamber volume and damping chamber outlets connected to the low pressure line to allow the coolant in the damping chamber volume to enter the low pressure line. Flow of the coolant into the low pressure line is distributed across the damping chamber outlets which are suitably configured (e.g., sized, shaped, and positioned) such that the coolant enters the low pressure line at multiple (i.e., two or more) discrete angular flow directions. Distributing the flow of the coolant into the low pressure line across the damping chamber outlets facilitates reducing or eliminating the ability of the coolant, which intersects the main refrigerant flowing through the low pressure line, to disturb the main refrigerant flow (e.g., to create a turbulent flow within the low pressure line). This facilitates improving the performance, efficiency, and longevity of the compressor.

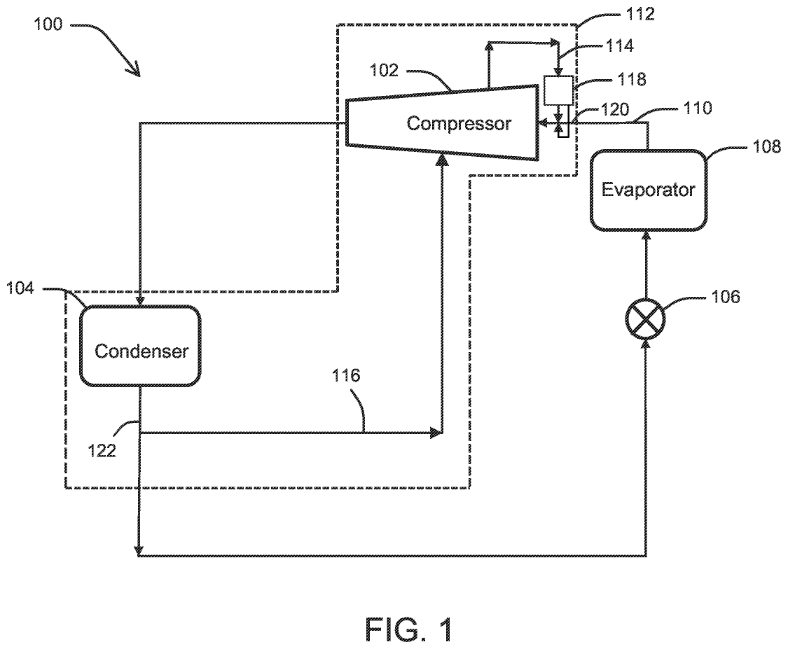

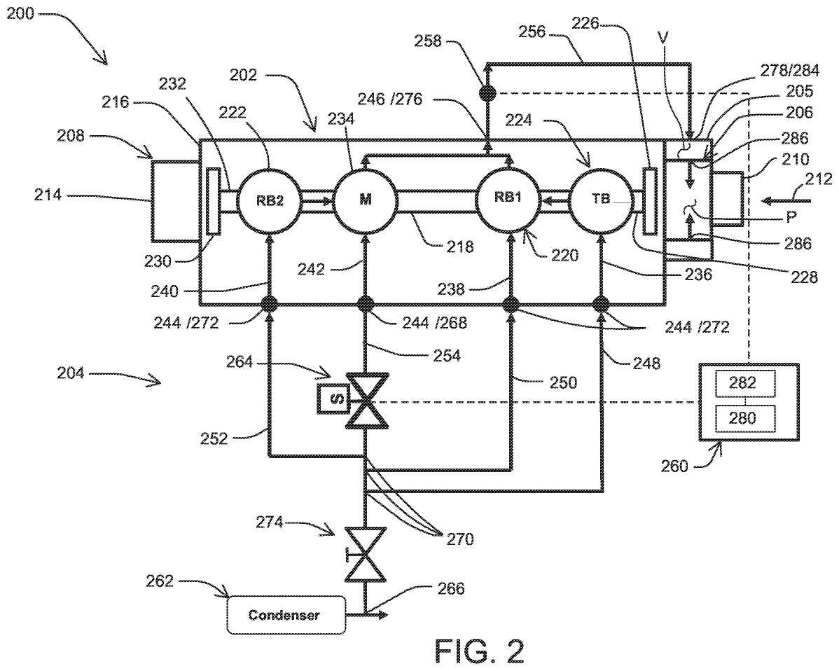

FIG. 1 is a schematic diagram of an example refrigeration system 100. The refrigeration system 100 includes a compressor 102, a condenser 104, an expansion device 106 (e.g., an expansion valve, orifice, capillary tube), and an evaporator 108. The compressor 102 may suitably be a centrifugal compressor (e.g., a centrifugal compressor 202 shown in FIG. 2). The refrigeration system 100 may include additional components or other components than those shown and described with reference to FIG. 1 without departing from the scope of the present disclosure.

In operation, the compressor 102 receives a working fluid, such as a refrigerant, as a low pressure gas through a suction line 110. The compressor 102 compresses the low pressure refrigerant gas, thereby raising the temperature and pressure of the refrigerant. The compressed, high temperature refrigerant exiting the compressor 102 is channeled towards and passes through the condenser 104, where the refrigerant is condensed to a high pressure liquid or a high pressure liquid-gas mixture. The compressed, condensed refrigerant exiting the condenser 104 is channeled towards and passes through the expansion device 106 that expands the refrigerant, thereby reducing the pressure of the refrigerant. The expanded (or “uncompressed”) refrigerant exiting the expansion device 106 may be a gas or a mixture of gas and liquid after passing through the expansion device 106. The uncompressed refrigerant exiting the expansion device 106 is channeled towards and passes through the evaporator 108. The evaporator 108 may include a heat exchanger, with a relatively high temperature fluid circulating therethrough that is cooled by the uncompressed refrigerant fluid. The uncompressed refrigerant fluid evaporates to a gas in the evaporator 108. The uncompressed refrigerant gas exiting the evaporator 108 is channeled back towards the compressor 102 via the suction line 110, where the working fluid is again compressed and the process repeats.

The example refrigeration system 100 includes a compressor cooling system 112 that draws working fluid (e.g., refrigerant) from part of the main refrigeration circuit (i.e., the refrigeration loop in which the working fluid is compressed using the compressor 102, condensed using the condenser 104, expanded using the expansion device 106, and evaporated using the evaporator 108). The working fluid used in the cooling system 112 is diverted from the main refrigeration circuit and channeled through a coolant supply line 116 towards the compressor 102 to cool components of the compressor 102, such as a motor and bearings of the compressor 102. The working fluid used in the cooling system 112 may also be referred to herein as “coolant.” The coolant is returned to the refrigeration circuit by a coolant return line 114 that channels the coolant towards a low pressure line 120 of the compressor 102. As used herein, “low pressure line” of a compressor (e.g., the compressor 102) refers to a refrigerant flow channel within the compressor or the main refrigeration circuit of which the compressor 102 is a part that precedes and channels refrigerant towards one or more impellers in the compression stages of the compressor (e.g., a first stage impeller of the compressor). The low pressure line 120 of the compressor 102 may include, for example and without limitation, a passage extending between an inlet of a first stage of the compressor 102 and a first stage impeller, the first stage inlet of the compressor 102, and the suction line 110 (e.g., the suction line 110) connected to the first stage inlet of the compressor 102.

The coolant used in the cooling system 112 is suitably drawn from a low temperature, high pressure side of the main refrigeration circuit downstream from the condenser 104 and upstream from the expansion device 106 (i.e., from a refrigerant line 122 connected between the condenser 104 and the expansion device 106), or, alternatively, from the condenser 104. Drawing the coolant from the main refrigeration circuit at this stage provides several advantages. The pressure differential across the cooling circuit 204 of the cooling system 112, i.e., the pressure differential between the high pressure refrigerant exiting the condenser 104 and the low pressure refrigerant entering the compressor 102 via the suction line 110, facilitates driving the coolant through the compressor 102, and back into the refrigeration circuit. The relatively low temperature refrigerant exiting the condenser 104, compared to a temperature of the refrigerant at downstream stages of the main refrigeration circuit (e.g., exiting the evaporator 108 and/or the expansion device 106), facilitates increasing the cooling capacity of the cooling system 112.

Using refrigerant from the high pressure side of the main refrigeration circuit as the coolant may create the opportunity to disturb the flow of the low pressure refrigerant of the main refrigeration circuit entering the compressor 102 via the suction line 110. Conventionally, the coolant enters the low pressure line 120 of the compressor 202 via a single outlet connecting the coolant return line 114 and the low pressure line 120. The coolant is drawn into the low pressure line 120 by a pressure differential between the coolant return line 114 and the low pressure line 120, and/or by a suction between the coolant return line 114 and the low pressure line 120 from the low pressure refrigerant flowing through the low pressure line 120. The coolant entering the low pressure line 120 via the single outlet intersects the low pressure refrigerant flowing through the low pressure line 120 at a single angular flow direction. The coolant intersecting the low pressure refrigerant at the single angular flow direction disturbs the flow of the low pressure refrigerant entering the compressor 102 and, thus, the flow of the refrigerant through the compressor 102. The performance, efficiency, and longevity of the compressor 102 may be substantially degraded by disturbances in the flow of the refrigerant through the compressor 102. For example, disturbances in the refrigerant flow may negatively impact a direction of the refrigerant flow contacting an impeller of the compressor 102. The direction of refrigerant flow may be controlled using inlet guide vanes positioned within the compressor 102 upstream from the impeller, however, the disturbances caused by the coolant intersecting the low pressure refrigerant at the single angular flow direction may substantially reduce the effectiveness of the guide vanes, particularly where the coolant enters the compressor 102 downstream from the inlet guide vanes.

Accordingly, still referring to FIG. 1, the cooling system 112 includes a damping chamber 118 that distributes flow of the coolant entering the low pressure line 120 such that the coolant intersects the low pressure refrigerant in the low pressure line 120 at multiple (i.e., two or more) flow directions spaced at angular intervals around a central axis of the low pressure line 120 (also referred to herein as “angular flow directions”). The damping chamber 118 is located between the coolant return line 114 and the low pressure line 120 (e.g., between the coolant return line 114 and the suction line 110). The damping chamber 118 has a damping chamber inlet connected to the coolant return line 114 through which the coolant enters a volume of the damping chamber 118. The damping chamber 118 also has one or more damping chamber outlets, and suitably multiple (i.e., two or more) damping chamber outlets, through which the coolant enters the low pressure line 120. The coolant enters the volume of the damping chamber 118 via the damping chamber inlet and accumulates within the damping chamber volume. The coolant within the damping chamber volume is driven through the damping chamber outlets and into the low pressure line 120 by a pressure differential between the coolant and the low pressure refrigerant entering the compressor 102 via the suction line 110 and/or by a suction between the damping chamber volume and the low pressure line 120 from the low pressure refrigerant flowing through the low pressure line 120. The damping chamber outlets are configured (e.g., sized, shaped, and positioned) such that coolant is driven therethrough and enters the low pressure line 120 at multiple discrete angular flow directions. Thereby, disturbances to the refrigerant flow through the low pressure line 120 caused by the intersecting coolant are reduced or eliminated, which facilitates improving the performance, efficiency, and longevity of the compressor 102.

FIG. 2 is a schematic diagram of an example compressor system 200 suitable for use in the refrigeration system 100 of FIG. 1. The compressor system 200 includes a compressor 202 (e.g., compressor 102) and a cooling circuit 204. The cooling circuit 204 delivers coolant to components of the compressor 202 to facilitate cooling the compressor 202 and maintaining components of the compressor 202 within suitable operating temperature ranges. The cooling circuit 204 includes a damping chamber 205 (e.g., the damping chamber 118) to distribute flow of the coolant entering a low pressure line of the compressor 202 (e.g., an inlet 210 of the compressor, or a passage P extending between an inlet 210 of the compressor 202 and an impeller 226 of the compressor 202).

The compressor 202 in the example shown in FIG. 2 is a two-stage centrifugal compressor 202 that includes a first stage 206 and a second stage 208. The compressor 202 may alternatively be a single stage centrifugal compressor (i.e., includes a single stage 206 or 208), or the compressor 202 may include more than two stages. The compressor 202 may be a compressor other than a centrifugal compressor. The first stage 206 includes a first stage inlet 210 that is connected in fluid communication with an evaporator (e.g., the evaporator 108 shown in FIG. 1) by a suction line 212 (e.g., the suction line 110 shown in FIG. 1). Low pressure refrigerant exiting the evaporator 108 enters the first stage 206 of the compressor 202 via the first stage inlet 210. The second stage 208 includes a second stage inlet 214 that is connected in fluid communication with a first stage outlet of the first stage 206 by a refrigerant transfer conduit (not shown in FIG. 2) to receive compressed refrigerant from the first stage 206.

The compressor 202 includes a housing 216, a shaft 218 rotatably supported in the housing 216. The shaft 218 may be supported in the housing 216 by bearings 220, 222, 224. Alternatively, the shaft 218 may be supported without the use of the bearings 220, 222, and/or 224. The compressor 202 also includes a first stage impeller 226 connected to a first end 228 of the shaft 218, a second stage impeller 230 connected to a second end 232 of the shaft 218, and a motor 234 operably connected to the shaft 218 to drive rotation thereof. The compressor 202 may include components in addition to those shown in FIG. 2.

The housing 216 encloses components of the compressor 202 within one or more sealed (e.g., hermetically or semi-hermitically) cavities. In some embodiments, for example, the housing 216 includes end caps at each stage of the compressor 202 that define volutes in which the first and second stage impellers 226, 230 are positioned. In some embodiments, the housing 216 is formed from cast pieces that are assembled using suitable fasteners (e.g., screws, bolts, etc.).

The bearings 220, 222, 224 may rotatably support the shaft 218 within the housing 216. In the example shown in FIG. 2, the compressor 202 includes a first radial bearing 220, a second radial bearing 222, and a thrust bearing 224. In other embodiments, the compressor 202 may include additional or fewer bearings. The bearings 220, 222, 224 may include any suitable type of bearings that enable the compressor 202 to function as described herein including, for example and without limitation, roller-type bearings, magnetic bearings, fluid film bearings, air foil bearings, and combinations thereof. In one example, each of the bearings 220, 222, 224 includes an air foil type bearing.

The motor 234 is operably connected to the shaft 218 to drive rotation thereof during operation of the compressor 202. The motor 234 may include any suitable motor that enables the compressor 202 to function as described herein. In the illustrated embodiment, the motor 234 is an electric motor and includes suitable components (e.g., a stator and a rotor) to impart rotational motion to the shaft 218 during operation of the compressor 202.

The housing 216 has coolant flow channels 236, 238, 240, 242 defined therein that channel coolant towards the bearings 220, 222, 224 and the motor 234. The coolant flow channels 236, 238, 240, 242 may be arranged and/or defined within the compressor housing 216 in any manner that enables the compressor system 200 to function as described herein. For example, the coolant flow channels 236, 238, 240, 242 may be formed as passages in components (e.g., cast components, as by machining, for example) of the compressor housing 216, as passages defined between two or more components of the compressor 202 (e.g., between the motor 234 and the compressor housing 216), and combinations thereof.

The example compressor 202 includes a first coolant flow channel 236, a second coolant flow channel 238, a third coolant flow channel 240, and a fourth coolant flow channel 242. The first coolant flow channel 236 delivers coolant to the thrust bearing 224, the second coolant flow channel 238 delivers coolant to the first radial bearing 220, the third coolant flow channel 240 delivers coolant to the second radial bearing 222, and the fourth coolant flow channel 242 delivers coolant to the motor 234. In some embodiments, the coolant flow channels 236, 238, 240, 242 may share common or overlapping portions. For example, as shown in FIG. 2, the first coolant flow channel 236 overlaps with and feeds into the second coolant flow channel 238 at the first radial bearing 220, and the third coolant flow channel 240 overlaps with and feeds into the fourth coolant flow channel 242 at the motor 234.

Each of coolant flow channels 236, 238, 240, 242 has a corresponding coolant inlet port 244 that connects to the cooling circuit 204 in the example embodiment. That is, the compressor housing 216 includes four external inlet connections for respectively connecting the coolant flow channels 236, 238, 240, 242 with coolant supply lines 248, 250, 252, 254. The compressor housing 216 may alternatively have fewer external inlet connections. For example, two or more of the coolant flow channels 236, 238, 240, 242 may share a common, single coolant inlet port (and a common connection point to one or more coolant supply lines) that provides coolant to multiple of the coolant flow channels 236, 238, 240, 242. In such examples, coolant flow delivered to the common coolant inlet port may be separated, divided, or otherwise routed within the compressor housing 216 to deliver coolant to two or more of the coolant flow channels 236, 238, 240, 242. In some embodiments, for example, the bearing coolant flow channels (i.e., the first, second, and third coolant flow channels 236, 238, 240) may have a common coolant inlet port, and the coolant flow may be routed to the separate flow channels internally within the compressor housing 216.

The compressor housing 216 also defines a common coolant outlet port 246. The common coolant outlet port 246 receives coolant from each of the coolant flow channels 236, 238, 240, 242. Alternatively stated, all the coolant channeled towards the compressor housing 216 and through the coolant flow channels 236, 238, 240, 242 is returned to the common coolant outlet port 246. In some embodiments, at least one of the coolant flow channels 236, 238, 240 is arranged such that coolant flows through at least one coolant flow channel, in series, across at least one of the bearings 220, 222, 224, through the motor 234, and to the common coolant outlet port 246. In this way, coolant flowing through the at least one coolant flow channel absorbs heat from both the motor 234 and one of the bearings 220, 222, 224. Coolant may flow through the motor 234, for example, by flowing between a stator and a rotor of the motor 234, through a portion of the shaft 218 around which the motor 234 is positioned, and/or through flow channels or holes defined in the rotor of the motor 234.

The cooling circuit 204 channels coolant towards the compressor housing 216 and the coolant flow channels 236, 238, 240, 242 via the coolant supply lines 248, 250, 252, 254. The coolant supply lines 248, 250, 252, 254 are connected in fluid communication with a coolant source 262 and are connected to the compressor housing 216 via the inlets 244 to deliver coolant to the coolant flow channels 236, 238, 240, 242. The coolant supply lines 248, 250, 252, 254 may include any suitable fluid conduit (rigid and/or flexible) that facilitates channeling the coolant to the compressor housing 216 including, for example and without limitation, pipes, hoses, tubes, and combinations thereof. In some embodiments, the coolant supply lines 248, 250, 252, 254 are constructed of metal tubing, such as copper tubing. The example cooling circuit 204 includes four coolant supply lines 248, 250, 252, 254, one for each of the coolant flow channels 236, 238, 240, 242 defined within the compressor housing 216. More specifically, the example cooling circuit 204 includes bearing coolant supply lines 248, 250, 252 and a motor coolant supply line 254. Each of the bearing coolant supply lines 248, 250, 252 is connected to one of the first, second, and third coolant flow channels 236, 238, 240 to channel or deliver coolant to at least one of compressor bearings 220, 222, 224. The motor coolant supply line 254 is connected to the fourth coolant flow channel 242 to deliver coolant to the motor 234.

The example coolant source 262 is suitably part of a main refrigeration circuit of which the compressor 202 is a part (e.g., the main refrigeration circuit of the refrigeration system 100 shown in FIG. 1). As described above, coolant may be drawn from the refrigeration circuit at or downstream from a condenser (e.g., the condenser 104 shown in FIG. 1) of the refrigeration circuit, such as between the condenser and an expansion device (e.g., the expansion device 106 shown in FIG. 1) of the refrigeration circuit. The coolant is the same working fluid (e.g., refrigerant) used in the refrigerant system in the example. The coolant source 262 may be a portion of the refrigeration system other than downstream from the condenser. For example, the coolant source 262 may be the condenser itself. The coolant source 262 may be any other suitable coolant source that enables the compressor system 200 to function as described herein. For example, the coolant source 262 may be an auxiliary liquid cycle.

Suitably, the coolant that is drawn from the coolant source 262 is driven through the cooling circuit 204 using a pressure differential between the coolant source 262 and a low pressure line upstream from the first stage impeller 226 of the compressor 202 (e.g., the first stage inlet 210, or the passage P extending between the first stage inlet 210 and the first stage impeller 226). The coolant may be driven by the pressure differential without the need for auxiliary equipment (e.g., a pump). In other examples, the coolant may be directed through the cooling circuit 204 using auxiliary equipment (e.g., a pump).

At least one of the coolant supply lines 248, 250, 252, 254 may include a coolant control valve 264 to control coolant flow through the corresponding coolant supply line. The control valve 264 may include an electrically-actuatable valve that is controllable by a controller 260 to vary or otherwise control the flow rate of coolant through the corresponding supply line. Suitable valves include, for example and without limitation, solenoid valves, electronic expansion valves, and modulating control valves. For example, the motor coolant supply line 254 includes the coolant control valve 264. Additionally and/or alternatively, one or more of the bearing coolant supply lines 248, 250, 252 may include a coolant control valve 264. For example, the motor coolant supply line 254 and one or more of the bearing coolant supply lines 248, 250, 252 may include a coolant control valve 264.

In the example shown in FIG. 2, the motor coolant supply line 254 is configured as a primary or main coolant supply line, having an inlet 266 connected to the coolant source 262 and an outlet 268 connected to the compressor housing 216 to deliver coolant to the fourth coolant flow channel 242. The bearing coolant supply lines 248, 250, 252 are configured as branch lines, each having an inlet 270 connected to the motor coolant supply line 254 upstream of the coolant control valve 264, and an outlet 272 connected to the compressor housing 216 to deliver the coolant to the first, second, and third coolant flow channels 236, 238, 240. In other examples, the inlet 270 of one or more of the bearing coolant supply lines 248, 250, 252 may be connected to the coolant source 262. The motor coolant supply line 254 may also be configured as a branch circuit extending off of one of the bearing coolant supply lines 248, 250, 252.

The cooling circuit 204 also includes a main shutoff valve 274 on the main coolant supply line (i.e., the motor coolant supply line 254) to enable coolant flow to the entire cooling circuit 204 to be shut off in order to isolate the compressor 202 (e.g., for servicing the compressor 202). The main shutoff valve 274 may alternatively be omitted.

The bearing coolant supply lines 248, 250, 252 may be free of individual shutoff valves or other devices that would individually cut the supply of coolant through the bearing coolant supply lines 248, 250, 252, as shown in FIG. 2. Thus, while the cooling circuit 204 is active (e.g., the main shut off valve 274 is open), the bearing coolant supply lines 248, 250, 252 are configured to continuously supply coolant to the compressor housing 216, irrespective of a position of the coolant control valve 264. In this way, the bearings of the compressor 202 are continuously supplied with coolant during operation to facilitate maintaining bearings within a suitable range of operating temperatures. The bearing coolant flow paths, including the bearing coolant supply lines 248, 250, 252 and the associated coolant flow channels 236, 238, 240 defined within the compressor housing 216, may include flow restrictors (not shown) along the flow path to restrict or otherwise limit the flow of coolant therethrough. The flow restrictors may be included in the bearing coolant supply lines 248, 250, 252 and/or may be integrated into the compressor housing 216 (e.g., as metering orifices along the coolant flow channels). In some embodiments, for example, one or more of the coolant inlet ports 244 associated with the bearing coolant flow channels 236, 238, 240 includes a metering orifice to control the flow of coolant therethrough.

The cooling circuit 204 also returns coolant from the coolant flow channels 236, 238, 240, 242 to the main refrigeration circuit (e.g., the main refrigeration circuit of the refrigeration system 100 shown in FIG. 1) of which the compressor 202 is a part. As shown in FIG. 2, the cooling circuit 204 includes a coolant return line 256 connected to the compressor housing 216 to receive coolant from the coolant flow channels 236, 238, 240, 242 and channel coolant towards a low pressure line of the compressor 202. The low pressure line of the compressor 202 refers to a refrigerant flow channel within the compressor 202 or the main refrigeration circuit of which the compressor 202 is a part that precedes and channels refrigerant towards the impellers of the compressor 202 (i.e., the first stage impeller 226 and the second stage impeller 228). In the example compressor system 200, the low pressure line includes the passage P extending between the first stage inlet 210 and the first stage impeller 226. In other examples, the low pressure line of the compressor 202 may include, for example and without limitation, the passage P, the first stage inlet 210, or the suction line 212 connected to the first stage inlet 210.

The coolant return line 256 may include any suitable fluid conduit (rigid and/or flexible) that facilitates channeling coolant between the coolant flow channels 236, 238, 240, 242 towards the lower pressure side of the compressor 202. Suitable conduits include, for example and without limitation, pipes, hoses, tubes, and combinations thereof. For example, the coolant return line 256 may be a conduit that is constructed of metal tubing, such as copper tubing, or the coolant return line 256 may be a conduit that is constructed of other materials.

In the example shown in FIG. 2, the coolant return line 256 extends between the housing 216 and the low pressure line of the compressor 202 external to the housing 216. Alternatively stated, the coolant return line 256 is depicted as an additional conduit separate from and connected to the housing 216. In some examples, the coolant return line 256 is defined by the housing 216 and extends within the housing 216 between the coolant flow channels 236, 238, 240, 242 and the low pressure line of the compressor 202. For example, the coolant return line 256 may be formed as a passage in components (e.g., cast components, as by machining, for example) of the compressor housing 216, as a passage defined between two or more components of the compressor 202 (e.g., between the motor 234 and the compressor housing 216), and combinations thereof. The coolant return line 256 may be hermetically or semi-hermetically sealed using hollow pins and O-rings, for example.

An inlet 276 of the coolant return line 256 is connected to the common coolant outlet port 246, and an outlet 278 of the coolant return line 256 is connected to an inlet 284 of the damping chamber 205. The coolant return line 256 receives, via the inlet 276, coolant from each of the coolant flow channels 236, 238, 240, 242 after the coolant absorbs heat from the motor 234 and/or the bearings 220, 222, 224. As noted above, at least one of the coolant flow channels 236, 238, 240, 242 may be arranged such that coolant flows through the at least one coolant flow channel, in series, across at least one of the bearings 220, 222, 224, through the motor 234, and to the common coolant outlet port 246. For example, as shown in FIG. 2, the third cooling flow channel 240 is arranged so the coolant flows, in series, across the second radial bearing 222, through the motor 234, and to the common coolant outlet port 246. As a result, coolant that flows through the coolant return line 256 has absorbed heat from at least one of the bearings 220, 222, 224 and the motor 234, even when the coolant control valve 264 is in an off position.

The cooling circuit 204 may also include a temperature sensor 258 connected to the coolant return line 256 to detect at least one of a temperature of the coolant return line 256 and a temperature of coolant within the coolant return line 256. The temperature sensor 258 may include any suitable temperature sensor that enables the cooling circuit 204 to function as described herein, including, for example and without limitation, thermistors (e.g., a negative temperature coefficient thermistor), thermocouples, resistance temperature detectors (RTDs), thermal switches, and combinations thereof.

The temperature sensor 258 of the example shown in FIG. 2 is located completely external of the compressor housing 216 and the coolant return line 256 and is configured to detect a temperature of the coolant return line 256. For example, the temperature sensor 258 may be connected to an external surface of the coolant return line 256 and is configured to detect a temperature of the external surface. Additionally and/or alternatively, the temperature sensor 258 may include a probe that extends within the coolant return line 256 to detect a temperature of coolant flowing through the coolant return line 256. For example, where the coolant return line 256 is defined by and extends within the housing 216, the temperature sensor 258 may include a probe that extends within the housing 216 and into the coolant return line 256.

The controller 260 is connected to the temperature sensor 258 and the coolant control valve 264 and is configured to control operation of the coolant control valve 264 (e.g., by opening, closing, or varying a position of the coolant control valve 264). In some embodiments, for example, the controller 260 is configured to control the coolant control valve 264 based on the temperature detected by the temperature sensor 258 to control the supply of coolant to the compressor housing 216. For example, the controller 260 may receive a signal from the temperature sensor 258 indicative of a temperature detected by the temperature sensor 258, compare the detected temperature to one or more temperature set points, and control the coolant control valve 264 based on the detected temperature. More specifically, based on the comparison, the controller 260 may be configured to open the coolant control valve 264, thereby permitting additional coolant flow through the motor coolant supply line 254 and to the motor 234, or close the coolant control valve 264, thereby reducing coolant flow through the motor coolant supply line 254 and to the motor 234. “Opening” and “closing” the coolant control valve 264 may refer to absolute opening and closing (i.e., completely opening and closing of the valve), or relative opening and closing of the valve (e.g., opening the valve more than it already is, or closing the valve more than it already is).

The controller 260 generally includes any suitable computer and/or other processing unit, including any suitable combination of computers, processing units and/or the like that may be communicatively connected to one another and that may be operated independently or in connection within one another (e.g., controller 260 may form all or part of a controller network). Controller 260 may include one or more modules or devices, one or more of which is enclosed within the compressor 202, or may be located remote from the compressor 202. The controller 260 may include one or more processor(s) 280 and associated memory device(s) 282 configured to perform a variety of computer-implemented functions (e.g., performing the calculations, determinations, and functions disclosed herein). As used herein, the term “processor” refers not only to integrated circuits, but also refers to a controller, a microcontroller, a microcomputer, a programmable logic controller (PLC), an application specific integrated circuit, and other programmable circuits. Additionally, memory device(s) 282 of controller 260 may generally be or include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 282 may generally be configured to store suitable computer-readable instructions that, when implemented by the processor(s), configure or cause controller 260 to perform various functions described herein including, but not limited to, controlling the coolant control valve 264 and/or various other suitable computer-implemented functions.

The controller 260 and/or components of the controller 260 may be integrated or incorporated within other components of the cooling circuit 204 and/or a refrigeration system within which the cooling circuit 204 is incorporated. For example, the controller 260 may be incorporated within the coolant control valve 264 and/or a system controller that controls other functions and operations of the compressor 202 and the refrigeration system.

The damping chamber 205 is located between the coolant return line 256 and the low pressure line (e.g., the passage P) of the compressor 202. The damping chamber 205 includes a damping chamber inlet 284 that is connected to the coolant return line outlet 278. The damping chamber 205 receives, via the damping chamber inlet 284, coolant from the coolant return line 256 that enters an interior volume V of the damping chamber 205. The damping chamber 205 also includes damping chamber outlets 286 connected to the low pressure line of the compressor 202 (e.g., the passage P). The coolant within the interior volume V of the damping chamber 205 exits the damping chamber 205 and enters the low pressure line (e.g., the passage P) of the compressor 202 via the damping chamber outlets 286.

In the example shown in FIG. 2, the damping chamber 205 is defined by the housing 216 and surrounds the passage P extending between the first stage inlet 210 and the first stage impeller 226. The damping chamber 205 defined by the housing 216 may additionally and/or alternatively surround the first stage inlet 210. In some examples, the damping chamber 205 may be separate from the housing 216. For example, the damping chamber 205 may be located adjacent to and surround the suction line 212 such that coolant enters the suction line 212 via the damping chamber outlets 286 upstream from the first stage inlet 210. The damping chamber 205 may be located at any suitable position to enable the damping chamber 205 to function as described herein.

The damping chamber outlets 286 connect the damping chamber volume V with the passage P and are located at discrete angular positions spaced in a circumferential-direction around the passage P. The damping chamber outlets 286 facilitate distributing flow of the coolant entering the passage P such that the coolant intersects the low pressure refrigerant in the passage P at multiple (i.e., two or more) angular flow directions. The damping chamber outlets 286 may include two or more outlets 286, such as three, four, five, six, or greater than six outlets 286.

The damping chamber outlets 286 may each have the same shape and/or size, or a shape and/or size of the damping chamber outlets 286 may vary. For example, the damping chamber outlets 286 may have the same cross-sectional size and/or shape, or the damping chamber outlets 286 may have different cross-sectional sizes and/or shapes. Additionally and/or alternatively, the damping chamber outlets 286 may have the same or different geometrical shape. The damping chamber outlets 286 may have any suitable geometric shape, such as, for example, prismatic (e.g., cylindrical), bell-shaped, conical, parabolic, and other shapes. Additionally and/or alternatively, the damping chamber outlets 286 may have the same orientation and/or a different orientation relative to a central axis of the passage P (and/or relative to a flow direction of the low pressure refrigerant in the passage P). In some examples, as shown in FIG. 2, the damping chamber outlets 286 may be oriented such that the coolant intersects the low pressure refrigerant substantially perpendicular in each angular flow direction. In other examples, some or all of the damping chamber outlets 286 may be oriented such that the coolant intersects the low pressure refrigerant at an oblique angle in some or all angular flow directions.

The damping chamber outlets 286 may be arranged in a staggered circumferential arrangement around the passage P, or the damping chamber outlets 286 may be aligned in a substantially circular circumferential arrangement around the passage P. The damping chamber outlets 286 may be arranged in any suitable formation to enable the damping chamber 205 to function as described herein. The damping chamber outlets 286 may be located in substantial axial alignment with the damping chamber inlet 284, or the damping chamber outlets 286 may be axially offset from the damping chamber inlet 284. For example, some or all the damping chamber outlets 286 may be located axially in closer proximity to the first stage inlet 210 than the damping chamber inlet 284, and/or some or all the damping chamber outlets 286 may be located axially in closer proximity to the first stage impeller 226 than the damping chamber inlet 284.

The damping chamber inlet 284 and the damping chamber outlets 286 may be formed as through-holes in components of the housing 216 that are spaced radially from one another and define the damping chamber volume V. Suitably, the damping chamber outlets 286 together define a cross-sectional area through which the coolant enters the passage P that is greater than or equal to a cross-sectional area defined by the damping chamber inlet 284 through which the coolant enters the damping chamber volume V. Thereby, back pressure to the coolant accumulating within the damping chamber volume V may be reduced or eliminated to enable the coolant to be driven into the passage P as described herein.

The coolant enters the volume V of the damping chamber 205 via the damping chamber inlet 284 and accumulates within the damping chamber volume V. The coolant within the damping chamber volume V is driven through the damping chamber outlets 286 and into the passage P by a pressure differential between the coolant and the low pressure refrigerant flowing through the passage P and/or by a suction at the damping chamber outlets 286 from the low pressure refrigerant flowing through the passage P. The damping chamber inlet 284 and the damping chamber outlets 286 are suitably sized to reduce or eliminate back pressure to the coolant accumulating in the damping chamber V such that the coolant is enabled to be driven into the passage P by the pressure differential and/or the suction. The coolant entering the passage P is distributed by the damping chamber outlets 286 to intersect the low pressure refrigerant flowing through the passage P at multiple discrete angular flow directions. Thereby, disturbances to the refrigerant flow through the passage P caused by the intersecting coolant are reduced or eliminated, which facilitates improving the performance, efficiency, and longevity of the compressor 202.

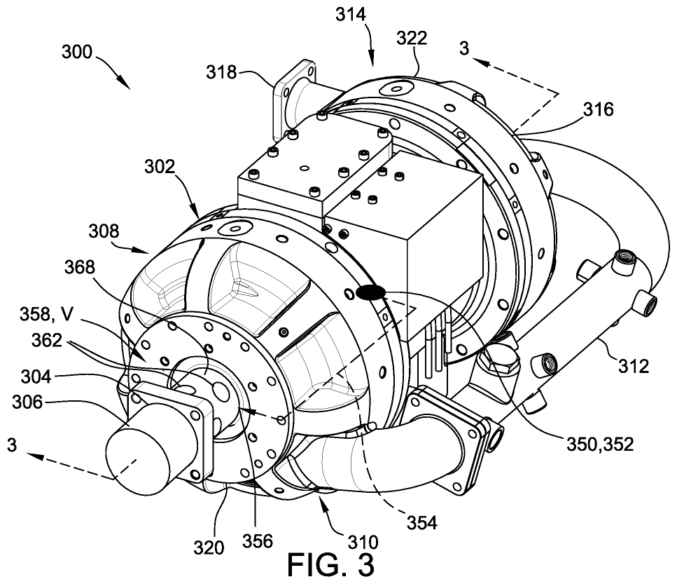

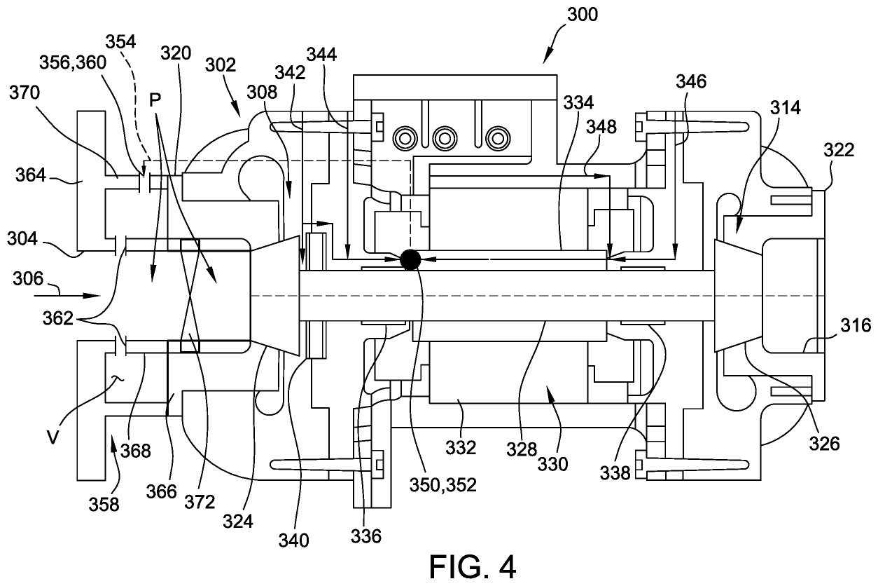

FIG. 3 is a perspective view of an example compressor 300 suitable for use in the refrigeration system 100 shown in FIG. 1 (e.g., as the compressor 102) and the compressor system 200 shown in FIG. 2 (e.g., as the compressor 202). FIG. 4 is a cross section of the compressor 300 of FIG. 3 taken along line 3-3. The example compressor 300 is a two-stage centrifugal compressor. The compressor 300 may alternatively include a single stage or more than two stages. The compressor 300 may also be a compressor other than a centrifugal compressor.

The compressor 300 includes a compressor housing 302 forming at least one sealed cavity within which each stage of refrigerant compression is accomplished. The compressor 300 includes a first refrigerant inlet 304 defined by the housing 302. The first refrigerant inlet 304 receives working fluid (e.g., low pressure refrigerant vapor) from a suction line 306 (e.g., the suction line 110 shown in FIG. 1 and the suction line 212 shown in FIG. 2). The refrigerant vapor enters the housing 302 via the first refrigerant inlet 304 and is channeled through a passage P towards a first compression stage 308. The refrigerant vapor is compressed within the first compression stage 308 and is channeled towards a first refrigerant exit 310. The compressor 300 also includes a refrigerant transfer conduit 312 to transfer compressed refrigerant from the first compression stage 308 towards a second compression stage 314. The refrigerant transfer conduit 312 is operatively connected at opposite ends with the first refrigerant exit 310 and a second refrigerant inlet 316 defined by the housing 302. Compressed refrigerant is channeled from the first compression stage 308 via the refrigerant transfer conduit 312 and enters the second compression stage 314 via the second refrigerant inlet 316. The refrigerant is compressed within the second compression stage 314 and is channeled towards a second refrigerant exit 318. The second refrigerant exit 318 delivers compressed refrigerant from the second compression stage 314 to a cooling system or refrigeration system (e.g., the refrigeration system 100) in which the compressor 300 is incorporated.

The compressor housing 302 includes a first housing end portion or cap 320 enclosing the first compression stage 308, and a second housing end portion or cap 322 enclosing the second compression stage 314. The first compression stage 308 and the second compression stage 314 are positioned at opposite ends of the compressor 300. The first and second compression stages 308, 314 may alternatively be located at the same end of the compressor 300. The first compression stage 308 includes a first impeller 324 configured to add kinetic energy to refrigerant entering via the first refrigerant inlet 304. The kinetic energy imparted to the refrigerant by the first impeller 324 is converted to increased refrigerant pressure (i.e., compression) as the refrigerant velocity is slowed upon transfer to a sealed cavity (e.g., a diffuser). The second compression stage 314 includes a second impeller 326 configured to add kinetic energy to refrigerant transferred from the first compression stage 308 entering via the second refrigerant inlet 316. The kinetic energy imparted to the refrigerant by the second impeller 326 is converted to increased refrigerant pressure (i.e., compression) as the refrigerant velocity is slowed upon transfer to a sealed cavity (e.g., a diffuser). Compressed refrigerant exits the second compression stage 314 via the second refrigerant exit 318.

The first impeller 324 and second impeller 326 are coupled at opposite ends of a driveshaft 328. The driveshaft 328 is operatively coupled to a motor 330 positioned within the housing 302 between the first impeller 324 and second impeller 326. The motor 330 operates to rotate the driveshaft 328 such that first impeller 324 and second impeller 326 are rotated at a rotation speed selected to compress the refrigerant to a pre-selected target (e.g., mass flow) exiting the second refrigerant exit 318. Any suitable motor may be incorporated into the compressor 300 including, but not limited to, an electrical motor. The example compressor 300 includes an electrical motor having a stator 332 connected to the compressor housing 302, and a rotor 334 connected to the driveshaft 328. An air gap (not labeled in FIG. 4) is defined between the stator 332 and the rotor 334 to allow coolant to flow therethrough. The driveshaft 328 is supported by first and second radial foil bearings 336, 338, and a thrust foil bearing 340. Additional details of the compressor 300, such as additional components and operation of the compressor 300, are described in U.S. Pat. No. 11,391,291, issued Jul. 19, 2022, the disclosure of which is incorporated herein by reference in its entirety.

As shown in FIG. 4, the compressor housing 302 includes coolant flow channels 342, 344, 346, and 348 defined therein that channel coolant within the housing 302 to provide cooling to the bearings 336, 338, 340 and the motor 330. The example compressor 300 includes a first coolant flow channel 342, a second coolant flow channel 344, a third coolant flow channel 346, and a fourth coolant flow channel 348. The first coolant flow channel 342 channels coolant towards the thrust bearing 340, the second coolant flow channel 344 channels coolant towards the first radial bearing 336, the third coolant flow channel 346 delivers coolant to the second radial bearing 338, and the fourth coolant flow channel 348 delivers coolant to the motor 330. The compressor housing 302 also defines a common coolant outlet port 350 that receives coolant from each of the coolant flow channels 342, 344, 346, and 348.

The first coolant flow channel 342 extends radially inward through the housing 302 near the first housing end cap 320, around the thrust bearing 340, and axially along the driveshaft 328 towards the common coolant outlet port 350. The second coolant flow channel 344 extends radially inward through the housing 302 towards the first radial bearing 336, and axially along the first radial bearing 336 and the driveshaft 328 towards the common coolant outlet port 350. The third coolant flow channel 346 extends radially inward through the housing 302 to the second radial bearing 338, and axially along the second radial bearing 338 and the driveshaft 328 towards the common coolant outlet port 350. The fourth coolant flow channel 348 extends helically around the stator 332 through a spiral groove (not shown in FIG. 4) defined by the compressor housing 302. The fourth coolant flow channel 348 then extends radially inward to the air gap defined between the stator 332 and the rotor 334, and axially through the air gap towards the common coolant outlet port 350.

As shown in FIG. 4, the coolant flow channels 342, 344, 346, 348 may share common or overlapping portions of the compressor housing 302. For example, the first coolant flow channel 342 overlaps with and feeds into the second coolant flow channel 344 at the first radial bearing 336. The third coolant flow channel 346 overlaps with and feeds into the fourth coolant flow channel 348 at the motor 330. Moreover, as shown in FIG. 4 and described above, the coolant flow channels 342, 344, 346, 348 within the example compressor housing 302 are arranged such that coolant flows through at least one of the coolant flow channels 342, 344, 346, 348, in series, across at least one of the bearings 336, 338, 340, through the motor 330, and to the common coolant outlet port 350. For example, the third coolant flow channel 346 delivers coolant to the second radial bearing 338 and the motor 330 (e.g., by flowing across the stator 332 and rotor 334), resulting in coolant absorbing heat from the bearings 336, 338, 340 and the motor 330.

A coolant return line 354 (shown schematically in dotted lines FIGS. 3 and 4) has an inlet 352 connected to the common coolant outlet port 350, and an outlet 356 connected to an inlet 360 of a damping chamber 358 (described further below) to return coolant to a low pressure line of the compressor 300 (e.g., the suction line 306, the first refrigerant inlet 304, and/or the passage P). The coolant return line 354 may extend external to the housing 302 between the inlet 352 and the outlet 356, that is, the coolant return line 354 may be an additional conduit separate from and connected to the housing 302. Additionally and/or alternatively, the coolant return line 354 may be defined by the housing 302 and extends within the housing 302 between the inlet 352 and the outlet 356. For example, the coolant return line 354 may be formed as a passage in components (e.g., cast components, as by machining, for example) of the compressor housing 302, as a passage defined between two or more components of the compressor housing 302 (e.g., between the motor 330 and the compressor housing 302), and combinations thereof. The coolant return line 354 may be hermetically or semi-hermetically sealed using hollow pins and O-rings, for example.

The low pressure refrigerant vapor flowing through the low pressure line of the compressor 300 (e.g., the suction line 306, the first refrigerant inlet 304, and/or the passage P) is at a lower pressure than the coolant delivered to the compressor housing 302. Suitably, the coolant is sourced from a relatively high pressure side of a refrigeration system (e.g., the refrigeration system 100 shown in FIG. 1) in which the compressor 300 is incorporated, such as at or downstream from a condenser (e.g., from the condenser 104 or the refrigerant line 122 connected between the condenser 104 and the expansion device 106 shown in FIG. 1). As a result, a pressure differential exists between the coolant at the coolant source and the low pressure line of the compressor 300. The pressure differential facilitates driving the coolant through the coolant flow channels 342, 344, 346, 348, and the coolant return line 354 towards the low pressure line of the compressor 300.

The damping chamber 358 is located between the coolant return line 354 and the low pressure line of the compressor 300 (e.g., the suction line 306, the first refrigerant inlet 304, and/or the passage P). The damping chamber 358 includes the damping chamber inlet 360 that is connected to the coolant return line outlet 356. The damping chamber 358 receives, via the damping chamber inlet 360, coolant from the coolant return line 354 that enters an interior volume V of the damping chamber 358. The damping chamber 358 also includes damping chamber outlets 362 connected to the low pressure line. In the example compressor 300, the damping chamber outlets 362 are connected to the passage P. The coolant within the interior volume V of the damping chamber 358 exits the damping chamber 358 and enters the passage P via the damping chamber outlets 362.

In the example compressor 300, as shown in FIG. 4, the damping chamber 358 is defined by the first housing end cap 320. The first housing end cap 320 also defines the passage P extending adjacent to the damping chamber 358 between the first refrigerant inlet 304 and the first impeller 324. The first housing end cap 320 includes an annular outer flange 364 for connecting the first refrigerant inlet 304 with the suction line 306. The first housing end cap 320 also includes an annular inner flange 366, and an inner tube 368 and an outer tube 370 each extending between the outer flange 364 and the inner flange 366. The outer tube 370 is spaced radially outward from the inner tube 368. Together, the outer and inner flanges 364, 366 and the inner and outer tubes 368, 370 define the damping chamber 358 and bound the interior volume V. In the example compressor 300, the inner tube 368 and the outer tube 370 are concentric cylinders and define a cylindrical shape of the damping chamber 358. The inner tube 368 and the outer tube 370, as described herein, are not limited to being cylindrically-shaped. The inner tube 368 and the outer tube 370 may have any other shape that enables the damping chamber 358 to function as described herein. For example, the inner tube 368 and the outer tube 370 may be formed as hollow, elongate structures having any suitable cross-sectional shape (e.g., a circular, oval, rectangular, or other polygonal shape). In the example compressor 300, the inner tube 368 and the outer tube 370 are radially coextensive between the outer flange 364 and the inner flange 366. In other examples, the inner tube 368 and the outer tube 370 may have different radial lengths between the outer flange 364 and the inner flange 366.

The inner tube 368 surrounds and at least partially defines the passage P and includes the damping chamber outlets 362 formed therein. The damping chamber outlets 362 are connected with the passage P such that coolant exiting the damping chamber 358 via the outlets 362 enters the passage P. The damping chamber outlets 362 are located at discrete angular positions spaced in a circumferential-direction along the inner tube 368. The damping chamber outlets 362 facilitate distributing flow of the coolant entering the passage P such that the coolant intersects the low pressure refrigerant in the passage P at multiple (i.e., two or more) angular flow directions. The damping chamber outlets 362 may include two or more outlets 362, such as three, four, five, six, or greater than six outlets 362. For example, the damping chamber outlets 362 may be formed as an annular or semi-annular array of through-holes that extends circumferentially along the inner tube 368. As shown in FIG. 3, in which the outer tube 370 and the outer flange 364 are omitted to show the interior volume V in greater detail, the damping chamber outlets 362 may be formed in a staggered circumferential arrangement along the inner tube 368. In other examples, the damping chamber outlets 362 may be aligned in a substantially circular circumferential arrangement along the inner tube 368. The damping chamber outlets 362 may be formed in any suitable formation to enable the damping chamber 358 to function as described herein.

The damping chamber outlets 362 may each have the same shape and/or size, or a shape and/or size of the damping chamber outlets 362 may vary. For example, the damping chamber outlets 362 may have the same cross-sectional size and/or shape, or the damping chamber outlets 362 may have different cross-sectional sizes and/or shapes. Additionally and/or alternatively, the damping chamber outlets 362 may have the same or different geometrical shape. The damping chamber outlets 362 may have any suitable geometric shape, such as, for example, prismatic (e.g., cylindrical), bell-shaped, conical, parabolic, and other shapes. Additionally and/or alternatively, the damping chamber outlets 362 may have the same orientation and/or a different orientation relative to a central axis of the passage P (and/or relative to a flow direction of the low pressure refrigerant in the passage P). In some examples, as shown in FIG. 4, the damping chamber outlets 362 may be oriented such that the coolant intersects the low pressure refrigerant substantially perpendicular in each angular flow direction. In other examples, some or all of the damping chamber outlets 362 may be oriented such that the coolant intersects the low pressure refrigerant at an oblique angle in some or all angular flow directions.

The outer tube 370 surrounds the interior volume V and the inner tube 368 and includes the damping chamber inlet 360 formed therein. In the example compressor 300, the damping chamber 358 includes a single damping chamber inlet 360. The damping chamber inlet 360 may alternatively include more than one inlet 360. The damping chamber inlet 360 may be formed as a through-hole in the outer tube 370. The damping chamber inlet 360 may be formed at any suitable location to facilitate connection with the outlet 356 of the coolant return line 354. In the example shown, the damping chamber inlet 360 is formed in the outer tube 370 to facilitate connection with the coolant return line 354 that extends at least partially external to the housing 302. In other examples, where the coolant return line 354 is defined by and extends within the housing 302, the damping chamber inlet 360 may be formed at another suitable location to facilitate connection with the outlet of the coolant return line 354. For example, the damping chamber inlet 360 may be formed in the inner flange 366.

Suitably, the damping chamber outlets 362 together define a cross-sectional area through which the coolant enters the passage P that is greater than or equal to a cross-sectional area defined by the damping chamber inlet 360 through which the coolant enters the damping chamber volume V. Thereby, back pressure to the coolant accumulating within the damping chamber volume V may be reduced or eliminated to enable the coolant to be driven into the passage P as described herein.

The damping chamber outlets 362 may be located in substantial axial alignment with the damping chamber inlet 360, or the damping chamber outlets 362 may be axially offset from the damping chamber inlet 360. For example, as shown in FIG. 4, some or all the damping chamber outlets 362 may be located axially in closer proximity to the first refrigerant inlet 304 than the damping chamber inlet 360. Additionally and/or alternatively, some or all the damping chamber outlets 362 may be located axially in closer proximity to the first impeller 324 than the damping chamber inlet 360.

The coolant enters the volume V of the damping chamber 358 via the damping chamber inlet 360 and accumulates within the damping chamber volume V. The coolant within the damping chamber volume V is driven through the damping chamber outlets 362 and into the passage P by a pressure differential between the coolant and the low pressure refrigerant flowing through the passage P and/or by a suction at the damping chamber outlets 362 from the low pressure refrigerant flowing through the passage P. The damping chamber inlet 360 and the damping chamber outlets 362 are suitably sized to reduce or eliminate back pressure to the coolant accumulating in the damping chamber V such that the coolant is enabled to be driven into the passage P by the pressure differential and/or the suction. The coolant entering the passage P is distributed by the damping chamber outlets 362 to intersect the low pressure refrigerant flowing through the passage P at multiple discrete angular flow directions. Thereby, disturbances to the refrigerant flow through the passage P caused by the intersecting coolant are reduced or eliminated, which facilitates improving the performance, efficiency, and longevity of the compressor 300.

As shown in FIG. 4, the compressor 300 may include variable inlet guide vanes 372 positioned in the passage P between the first refrigerant inlet 304 and the first impeller 324. The position of the guide vanes 372 may be controlled to impart the direction of the flow of the refrigerant flowing through the passage P such that the refrigerant contacts the first impeller 324 with a suitable direction. The damping chamber 358 in the example shown in FIG. 4 is positioned such that the damping chamber outlets 362 are upstream from the guide vanes 372. Thus, coolant entering the passage P via the damping chamber outlets 362 mixes with the low pressure refrigerant vapor in the passage P upstream from the guide vanes 372. Suitably, positioning the damping chamber outlets 362 upstream from the guide vanes 372 enables the guide vanes 372 to impart the flow direction of the refrigerant after the coolant is mixed with the low pressure refrigerant vapor in the passage P.

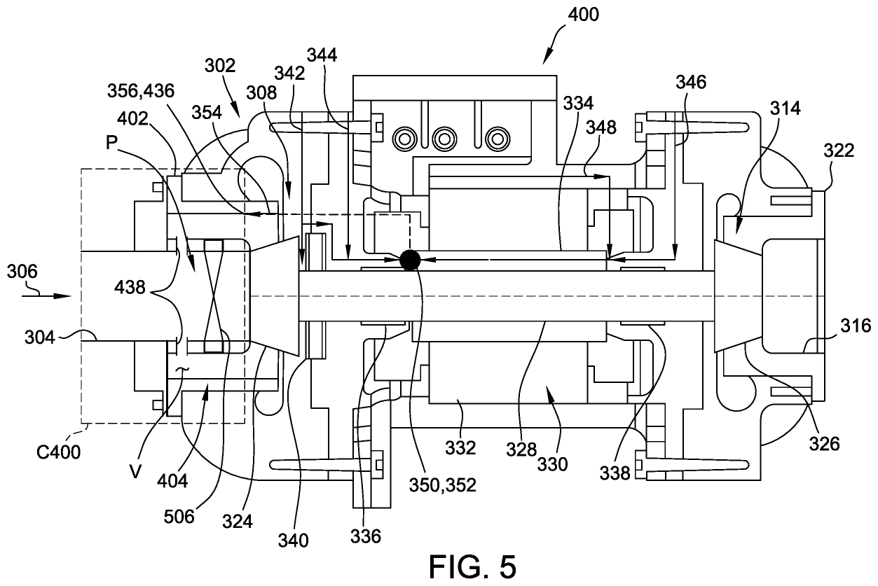

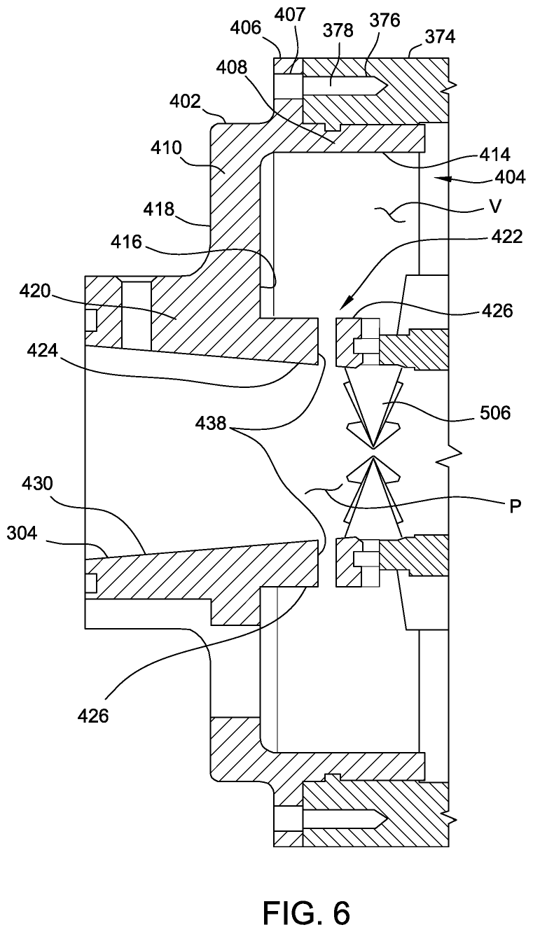

Referring now to FIGS. 5 and 6, another example compressor 400 is shown. FIG. 5 is cross section of the compressor 400, taken along a section line similar to line 3-3 shown in FIG. 3. FIG. 6 is an enlarged view of a portion of the compressor 400 shown in FIG. 5, indicated by Section C₄₀₀. The compressor 400 has a similar configuration as the compressor 300 shown in FIGS. 3 and 4. Like the compressor 300, the compressor 400 is suitable for use in the refrigeration system 100 shown in FIG. 1 (e.g., as the compressor 102) and the compressor system 200 shown in FIG. 2 (e.g., as the compressor 202). Reference characters in FIGS. 5 and 6 corresponding to reference characters of FIGS. 3 and 4 are used to indicate corresponding parts between the compressor 400 and the compressor 300.

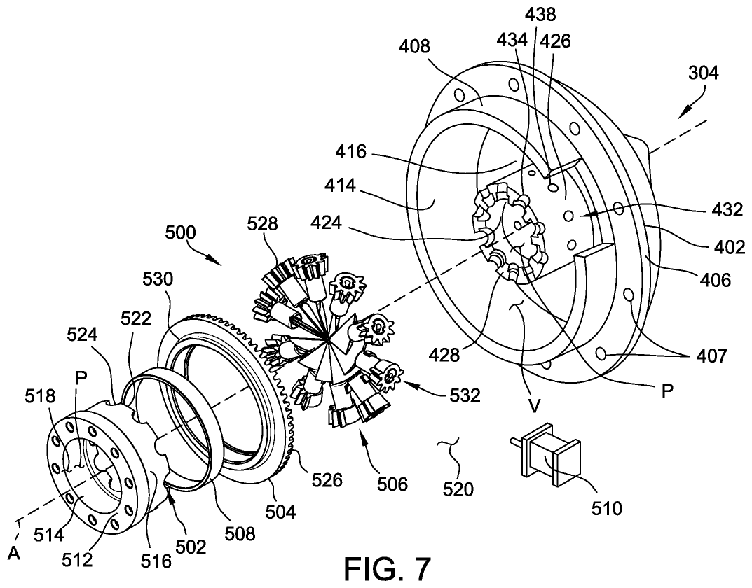

The compressor 400 includes a damping chamber 404 defined by a first housing end cap 402. The first housing end cap 402 is included with the compressor housing 302 and connected to a main body 374 thereof. The damping chamber also defines the first refrigerant inlet 304 of the compressor 400. The damping chamber 404 surrounds the passage P extending between the inlet 304 and the first impeller 324. In this example, the damping chamber 404 is defined axially downstream from the inlet 304. In addition, the first housing end cap 402 defines a portion of an inlet guide vane apparatus 500 (shown in FIG. 7) installed in the compressor 400. The inlet guide vane apparatus 500 is described in more detail below and may also be referred to as an inlet guide 500. Additional details of the inlet guide 500, such as additional components and operation of the inlet guide 500, are described in U.S. patent application Ser. No. 18/186,273, filed Mar. 20, 2023, the disclosure of which is incorporated herein by reference in its entirety.

The first housing end cap 402 includes an annular flange 406 that defines a radially outermost portion of the end cap 402. The annular flange 406 is connected to the main body 374 of the compressor housing 302. The annular flange 406 includes holes 407 formed therein that align with corresponding holes 376 formed in the main housing body 374. The aligned end cap holes 407 and corresponding main body holes 376 receive fasteners 378 to connect the first housing end cap 402 with the main housing body 374.

The annular flange 406 extends radially outwardly from an annular sidewall 408 of the first housing end cap 402. The annular sidewall 408 extends axially from a shoulder 410 of the end cap 402. The end cap 402 is open at the end of the annular sidewall 408 opposite the shoulder 410. A recessed surface 416 that faces the main housing body 374 is defined by the shoulder 410 and extends radially between the annular sidewall 408 and an interior wall 422. The damping chamber volume V is defined by an interior surface 414 of the annular sidewall 408, the recessed surface 416, and an outer surface 426 of the interior wall 422. The shoulder 410 also defines an exterior surface 418 opposite the recessed surface 416. The end cap 402 also includes a neck portion 420 extending axially from the shoulder 410. The neck portion 420 has a smaller outer diameter than the annular sidewall 408. The shoulder 410 extends radially between and joins the neck portion 420 and the annular sidewall 408.

The end cap 402 includes the interior wall 422 that extends axially outwardly from the recessed surface 416. The interior wall 422 is spaced radially from the annular sidewall 408 to define the damping chamber volume V. The interior wall 422 also forms a portion of the inlet guide 500 that is defined by and made integral with the end cap 402. In particular, the interior wall 422 forms a second housing portion of the inlet guide 500 that is made integral with the end cap 402. The interior wall 422 may be made integral with the end cap 402 by manufacturing techniques including, but not limited to, casting, molding, powder metal manufacturing, additive manufacturing or 3D printing, and machining (e.g., computer numerical control machining). The end cap 402 and the interior wall 422 may be made from any suitable material including, for example, cast iron, aluminum, steel, and alloys thereof, as well as plastic, and any combination of these materials. The end cap 402 and the interior wall 422 may also be made from graphite or another suitable self-lubricating material that may be added to a casting or molding, for example. Making the end cap 402 and the interior wall 422 from a self-lubricating material may negate the need for a bearing in the inlet guide 500 (shown in FIG. 7) to facilitate rotation of a ring gear 504 relative to the interior wall 422 and/or a housing portion 502.

The end cap 402 also includes a central bore 430 that is defined by the neck portion 420 and the interior wall 422. The central bore 430 extends axially through the cap 402 and defines the first refrigerant inlet 304 of the compressor 400 and a boundary of the passage P. The interior wall 422 surrounds a portion of the passage P. As shown in FIG. 6, the central bore 430 is generally conical in shape and a diameter defined by the central bore 430 decreases in a direction from the refrigerant inlet 304 towards the first impeller 324 (shown in FIG. 5). The central bore 430 may alternatively be generally cylindrical in shape and defines a generally constant diameter.

The inlet guide 500 is mounted in proximity to the refrigerant inlet 304 of the compressor 400. Low pressure refrigerant vapor is channeled towards the inlet guide 500 through the passage P and exits the inlet guide 500 with a suitable flow direction. The refrigerant is then channeled towards the first compression stage 308 (shown in FIG. 5), and the refrigerant contacts the first impeller 324 of the compressor 400 with a suitable direction. Alternatively, and/or additionally, the inlet guide vane 500 is mounted in proximity to the inlet for each stage of a multi-stage compressor (e.g., the first refrigerant inlet 304 and the second refrigerant inlet 316).

Additional features and elements of the inlet guide 500 will now be described with reference to FIG. 7, which depicts an exploded view of the inlet guide 500. The inlet guide 500 includes the end cap 402 and a housing portion 502. When the inlet guide 500 is assembled, the interior wall 422 is connected to the housing portion 502. The end cap 402, and thus the interior wall 422, is positioned axially upstream from the housing portion 502 when the inlet guide 500 is installed in the compressor 400. The interior wall 422 and the housing portion 502 directly connect to form a guide vane housing assembly. Thus, the housing portion 502 is directly connected to the end cap 402. The housing portion 502 and the interior wall 422 may be connected in any suitable manner that enables the inlet guide 500 to function as described herein. For example, the housing portion 502 may be connected to the interior wall 422 by screws or other suitable fasteners.

In addition to the housing portion 502 and the interior wall 422, the inlet guide 500 includes a ring gear 504 and guide vanes 506. The ring gear 504 is rotatably connected to the housing portion 502 and/or to the interior wall 422 and may be rotatably supported within the inlet guide 500 by a bearing 508. Each guide vane 506 is rotatable relative to the vane housing assembly of the inlet guide 500 and is operably connected to the ring gear 504 such that rotation of the ring gear 504 causes each of the guide vanes 506 to rotate in unison. Each of the guide vanes 506 is rotatable relative to the vane housing assembly of the inlet guide 500 such that the orientation of the guide vanes 506 within the passage P, defined by the housing portion 502 and the interior wall 422, is selectively adjustable. In some embodiments, the guide vanes 506 are rotatable relative to the vane housing assembly of the inlet guide 500 in unison. The inlet guide 500 may also include one or more motors 510 operably connected to one or more of the guide vanes 506 to selectively rotate the guide vanes 506.

The housing portion 502 includes an annular wall 512 having a first inner surface 514 and a first outer surface 516. The interior wall 422 has a second inner surface 424 and a second outer surface 426. The first inner surface 514 and the second inner surface 424 define the boundary of the passage P extending through the vane housing assembly. The housing portion 502 defines an exit or outlet 518 of the inlet guide 500. Refrigerant being channeled through the passage P enters the vane housing assembly of the inlet guide 500, contacts the guide vanes 506, exits the vane housing assembly via the outlet 518, and is channeled towards the first impeller 324 (shown in FIG. 5). The refrigerant exiting the vane housing assembly via the outlet 518 has a suitable flow direction imparted by the guide vanes 506.

The vane housing assembly of the inlet guide 500 includes an exterior area 520 surrounding the first outer surface 516 and the second outer surface 426 and located radially outward from the vane housing assembly. At least a portion of each of the guide vanes 506 is positioned between the housing portion 502 and the interior wall 422, and at least a portion of the guide vanes 506 and the ring gear 504 are arranged in the exterior area 520. Accordingly, the ring gear 504 and at least a portion of the guide vanes 506 are accessible (e.g., to an operator or technician) for inspection and/or repairs without requiring inlet guide 500 to be disassembled. By way of example, an operator or technician may access the ring gear 504 and a portion of the guide vanes 506 without first disconnecting the housing portion 502 from the end cap 402. The annular sidewall 408 may include a cut out 432 formed in the sidewall 408. The cut out 432 renders the sidewall 408 discontinuous along a circumferential extent and provides clearance to enable access to the ring gear 504 and a portion of the guide vanes 506 without disassembling the vane housing assembly. The cut out 432 may additionally, and/or alternatively, provide clearance for connecting the one or more motors 510 to one or more of the guide vanes 506.

The interior wall 422 includes a downstream surface 428 that is generally annular in shape. The interior wall 422 may have a width extending between the second outer surface 426 and the second inner surface 424 that is similar to a width of the annular wall 512 of the housing portion 502 extending between the first inner surface 514 and the first outer surface 516. An axial length of a portion of the passage P extending through the vane housing assembly is defined by an axial length of the interior wall 422 and the annular wall 512. A diameter of the passage P extending through the vane housing assembly is defined by a diameter of the second inner surface 424 and the first inner surface 514. The dimensions of the vane housing assembly, e.g., diameter and length, may be scaled to the size of the compressor 400 and the aerodynamic needs of the compressor 400 to define suitable dimensions of the passage P extending through the vane housing assembly.

The downstream surface 428 of the interior wall 422 includes second channels 434 arranged in a radially symmetric pattern about the downstream surface 428. An upstream surface 522 of the housing portion 502 includes first channels 524 arranged in a radially symmetric pattern about the upstream surface 522. The upstream surface 522 includes the same number of the first channels 524 as the number of second channels 434 included in the downstream surface 428. Each of the first and second channels 524, 434 may be identical, having the same size and shape. In the example inlet guide 500, the first and second channels 524, 434 are in the shape of a segment of a cylinder. When the inlet guide 500 is assembled, each of the first channels 524 aligns with one of the second channels 434 to cooperatively form guide vane channels extending radially through the vane housing assembly. The guide vane channels so formed are sized and shaped to receive at least a portion of the guide vanes 506 therein.

The guide vanes 506 are received by the guide vane channels formed by aligning first and second channels 524, 434 and are arranged in a radially symmetric pattern mirroring the radially symmetric pattern of the first and second channels 524, 434. The number of guide vanes 506 corresponds to the number of the first and second channels 524, 434. In the example inlet guide 500, there are ten guide vanes 506 corresponding to ten first channels 524 and ten second channels 434. The inlet guide 500 may include any suitable number of guide vanes 506 that enables the inlet guide 500 to function as described herein. For example, the inlet guide 500 may include six guide vanes 506, seven guide vanes 506, eight guide vanes 506, nine guide vanes 506, or more than ten guide vanes 506.

Each of the guide vanes 506 received by one of the guide vane channels are at least partially positioned in the portion of the passage P that extends through the vane housing assembly. The guide vanes 506 have any shape or size enabling the inlet guide 500 to function as describe herein. Additionally, the shape and size of the guide vanes 506 may be selected based upon the intended application of the inlet guide 500. For example, the size, shape, and angle of the guide vanes 506 may be selected based on the type and configuration of the compressor 400, the operating conditions, and/or the fluid type used with the compressor 400. Each of the guide vanes 506 is rotatable relative to the vane housing assembly of the inlet guide 500 such that the orientation of the each of the guide vanes 506 within the passage P is selectively adjustable.

The ring gear 504 is rotatably connected to the housing portion 502 and/or the interior wall 422 and rotatable about a central axis A defined by the inlet guide 500. The ring gear 504 includes gear teeth 526 that are sized and shaped to mate with vane gear teeth 528 of each of the guide vanes 506. Rotation of the ring gear 504 is transmitted to the vane gear teeth 528, causing rotation of the guide vanes 506 within the guide vane channels of the inlet guide 500.

The ring gear 504 further includes a feature 530 on a surface opposite the gear teeth 526. The feature 530 engages with the bearing 508, preventing the bearing 508 from translating axially relative to the ring gear 504.

The ring gear 504, and the vane gear teeth 528, are arranged in the exterior area 520 of the inlet guide 500, enabling an operator to inspect and/or repair the ring gear 504 without disconnecting the housing portion 502 and the interior wall 422. At least one of the guide vanes 506 may be a drive guide vane 532 that is operably connected to motor 510 that drives rotation of the drive guide vane 532. Rotation of the drive guide vane 532 causes rotation of the ring gear 504, which transmits rotation to the rest of the guide vanes 506, also referred to as follower guide vanes. Accordingly, all the guide vanes 506 rotate in unison. The motor 510 may be a stepper motor. The motor may communicatively be connected to a controller (e.g., the controller 260) and the controller transmits one or more instructions to the motor causing the motor to rotate the drive guide vane 532 in order to arrange the guide vanes 506 in a suitable orientation within the passage P. Simultaneous rotation of the guide vanes 506 changes the orientations of the guide vanes 506 relative to refrigerant flow through the vane housing assembly. The guide vanes 506 may be rotated, in unison, to arrange the inlet guide 500 to any suitable position, for example, to a fully open or neutral position, relative to the refrigerant flow, based on the operational needs of the compressor 400. For example, the position of the guide vanes 506 may be selected to increase the operating range of the compressor 400, including both surge and choke.

The inlet guide 500 may include the bearing 508 arranged between the housing portion 502 and the ring gear 504. The bearing 508 facilitates rotation of the ring gear 504 relative to the housing portion 502. The bearing 508 may be connected to the ring gear 504, e.g., the bearing 508 is press fit into frictional engagement with the feature 530. Accordingly, the ring gear 504 and the bearing 508 rotate relative to the housing portion 502. Alternatively, the bearing 508 may be press fit onto housing portion 502 such that the bearing 508 and the housing portion 502 are frictionally engaged and the ring gear 504 rotates relative to the bearing 508 and the housing portion 502. The bearing 508 may be a non-lubricating bearing or a self-lubricating bearing, and the bearing 508 may include any suitable type of bearing 508 that enables the inlet guide 500 to function as described herein. The bearing 508 may also be omitted and the ring gear 504 may rotate relative to the housing portion 502, without the use of a bearing. For example, the housing portion 502 and/or the interior wall 422 may be made from a self-lubricating material (e.g., graphite) that may negate the need for a bearing.

Referring again to FIGS. 5-7, the damping chamber 404 defined by the first housing end cap 402 is located between the coolant return line 354 and the passage P of the compressor 400. In the example compressor 400, the coolant return line 354 is formed as a passage in components (e.g., cast components, as by machining, for example) of the main body 374 of the compressor housing 302. The coolant return line 354 formed as an internal passage in components of the main body 374 extends between the common coolant outlet port 350 and the outlet 356. The common coolant outlet port 350 may be formed adjacent to the air gap defined between the stator 332 and the rotor 334. The coolant return line 354 extends axially and internally from the common coolant outlet port 350 through components of the main body 374 and to the outlet 356. The outlet 356 of the coolant return line 354 is formed as an external opening in the main body 374 that allows coolant to enter the damping chamber volume V defined by the first housing end cap 402. The outlet 356 thereby also forms a damping chamber inlet 436 through which coolant flows to enter the damping chamber volume V. The damping chamber volume V is sealed by the annular flange 406, the annular sidewall 408, and the shoulder 410 of the end cap 402. The coolant return line 354 may be hermetically or semi-hermetically sealed using hollow pins and O-rings, for example.

The damping chamber 404 also includes damping chamber outlets 438 connected to the passage P. The coolant within the damping chamber volume V exits the damping chamber 404 and enters the passage P of the compressor 400 via the damping chamber outlets 438. The damper chamber outlets 438 are formed in the interior wall 422 axially upstream from the second channels 434 formed in the downstream surface 428. Thus, the damping chamber outlets 438 are connected with the passage P upstream from the guide vanes 506 such that coolant exiting the damping chamber 404 via the outlets 438 enters the passage P and mixes with the low pressure refrigerant vapor upstream from the guide vanes 506.

The damping chamber outlets 438 are located at discrete angular positions spaced in a circumferential-direction along the interior wall 422. The damping chamber outlets 438 facilitate distributing flow of the coolant entering the passage P such that the coolant intersects the low pressure refrigerant in the passage P at multiple (i.e., two or more) angular flow directions. The damping chamber outlets 438 may include two or more outlets 438, such as three, four, five, six, or greater than six outlets 438. For example, the damping chamber outlets 438 may be formed in the interior wall 422 as an annular or semi-annular array of through-holes that extends circumferentially along the interior wall 422. In some examples, the damping chamber outlets 438 may be formed in a staggered circumferential arrangement along the interior wall 422. In other examples, the damping chamber outlets 438 may be aligned in a substantially circular circumferential arrangement along the interior wall 422. The damping chamber outlets 438 may be formed in any suitable formation to enable the damping chamber 404 to function as described herein.

The damping chamber outlets 438 may each have the same shape and/or size, or a shape and/or size of the damping chamber outlets 438 may vary. For example, the damping chamber outlets 438 may have the same cross-sectional size and/or shape, or the damping chamber outlets 438 may have different cross-sectional sizes and/or shapes. Additionally and/or alternatively, the damping chamber outlets 438 may have the same or different geometrical shape. The damping chamber outlets 438 may have any suitable geometric shape, such as, for example, prismatic (e.g., cylindrical), bell-shaped, conical, parabolic, and other shapes. Additionally and/or alternatively, the damping chamber outlets 438 may have the same orientation and/or a different orientation relative to a central axis of the passage P (and/or relative to a flow direction of the low pressure refrigerant in the passage P). In some examples, as shown in FIG. 6, the damping chamber outlets 438 may be oriented such that the coolant intersects the low pressure refrigerant substantially perpendicular in each angular flow direction. In other examples, some or all of the damping chamber outlets 438 may be oriented such that the coolant intersects the low pressure refrigerant at an oblique angle in some or all angular flow directions. For example, some or all the damping chamber outlets 438 may be oriented at an oblique angle towards the guide vanes 506 such that coolant in some or all angular flow directions flows generally towards the guide vanes 506.

Suitably, the damping chamber outlets 438 together define a cross-sectional area through which the coolant enters the passage P that is greater than or equal to a cross-sectional area defined by the damping chamber inlet 436 through which the coolant enters the damping chamber volume V. Thereby, back pressure to the coolant accumulating within the damping chamber volume V may be reduced or eliminated to enable the coolant to be driven into the passage P as described herein.

The coolant enters the volume V of the damping chamber 404 via the damping chamber inlet 436 and accumulates within the damping chamber volume V. The coolant within the damping chamber volume V is driven through the damping chamber outlets 438 and into the passage P by a pressure differential between the coolant and the low pressure refrigerant flowing through the passage P and/or by a suction at the damping chamber outlets 438 from the low pressure refrigerant flowing through the passage P. The damping chamber inlet 436 and the damping chamber outlets 438 are suitably sized to reduce or eliminate back pressure to the coolant accumulating in the damping chamber V such that the coolant is enabled to be driven into the passage P by the pressure differential and/or the suction. The coolant entering the passage P is distributed by the damping chamber outlets 438 to intersect the low pressure refrigerant flowing through the passage P at multiple discrete angular flow directions. Thereby, disturbances to the refrigerant flow through the passage P caused by the intersecting coolant are reduced or eliminated, which facilitates improving the performance, efficiency, and longevity of the compressor 400.

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A refrigeration system comprising:
a compressor comprising:
a housing;
a shaft rotatably supported in the housing;
an impeller connected to the shaft; and
a motor operably connected to the shaft;
an evaporator connected to a low pressure line of the compressor;
a condenser;
an expansion device; and
a cooling circuit comprising:
at least one coolant supply line to channel a coolant from one of the condenser and a refrigerant line connected between the condenser and the expansion device towards the housing;
at least one coolant flow channel defined by the housing that receives the coolant from the at least one coolant supply line and channels the coolant towards the motor;
a coolant return line to channel the coolant from the at least one coolant flow channel towards the low pressure line of the compressor; and
a damping chamber located between the coolant return line and the low pressure line of the compressor, the damping chamber comprising:
a damping chamber inlet connected to the coolant return line to allow the coolant to enter a damping chamber volume from the coolant return line; and
damping chamber outlets connected to the low pressure line of the compressor to allow the coolant in the damping chamber volume to enter the low pressure line of the compressor.

2. The refrigeration system of claim 1, wherein the housing defines a passage extending between a compressor inlet and the impeller, the damping chamber outlets being connected to the passage to allow the coolant in the damping chamber volume to enter the passage.

3. The refrigeration system of claim 2, wherein guide vanes are positioned within the passage, wherein the damping chamber outlets are connected to the passage upstream from the guide vanes.

4. The refrigeration system of claim 1, wherein the damping chamber outlets are configured to allow the coolant to enter the low pressure line of the compressor at discrete angular flow directions.

5. The refrigeration system of claim 1, wherein the damping chamber outlets together define a cross-sectional area through which the coolant enters the low pressure line of the compressor that is greater than or equal to a cross-sectional area defined by the damping chamber inlet through which the coolant enters the damping chamber volume.

6. The refrigeration system of claim 1, wherein the damping chamber is defined by an end cap of the housing.

7. The refrigeration system of claim 6, wherein the damping chamber volume is defined between an inner tube and an outer tube of the end cap, the inner tube at least partially defining a passage extending between a compressor inlet and the impeller, the inner tube having the damping chamber outlets formed therein, the damping chamber outlets being connected to the passage.

8. The refrigeration system of claim 7, wherein the damping chamber inlet is formed in the outer tube and the coolant return line is connected between the at least one coolant flow channel and the damping chamber inlet, the coolant return line being external to the housing.

9. The refrigeration system of claim 8, wherein the damping chamber outlets are axially offset from the damping chamber inlet.

10. The refrigeration system of claim 7, wherein the coolant return line is defined by the housing and extends within the housing between the at least one coolant flow channel and the damping chamber.

11. A compressor system comprising:
a compressor comprising:
a housing defining a compressor inlet;
a shaft rotatably supported in the housing;
an impeller connected to the shaft, wherein the housing has a passage extending between the compressor inlet and the impeller; and
a motor operably connected to the shaft; and
a cooling circuit comprising:
at least one coolant flow channel defined by the housing to receive a coolant and channel the coolant towards the motor;
a coolant return line to channel the coolant from the at least one coolant flow channel towards the passage; and
a damping chamber located between the coolant return line and the passage, the damping chamber comprising:
a damping chamber inlet connected to the coolant return line to allow the coolant to enter a damping chamber volume from the coolant return line; and
damping chamber outlets connected to the passage to allow the coolant in the damping chamber volume to enter the passage at discrete angular flow directions.

12. The compressor system of claim 11, wherein the damping chamber comprises a single damping chamber inlet connected to the coolant return line.

13. The compressor system of claim 11, wherein the damping chamber outlets together define a cross-sectional area through which the coolant enters the passage that is greater than or equal to a cross-sectional area defined by the damping chamber inlet through which the coolant enters the damping chamber volume.

14. The compressor system of claim 11, wherein the compressor inlet and the damping chamber are defined by an end cap of the housing, the damping chamber volume being defined between an inner tube and an outer tube of the end cap, the inner tube at least partially defining the passage and having the damping chamber outlets formed therein.

15. The compressor system of claim 14, wherein the damping chamber inlet is formed in the outer tube and the coolant return line is connected between the at least one coolant flow channel and the damping chamber inlet, the coolant return line being external to the housing.

16. The compressor system of claim 15, wherein the damping chamber outlets are axially offset from the damping chamber inlet.

17. The compressor system of claim 14, wherein the coolant return line is defined by the housing and extends within the housing between the at least one coolant flow channel and the damping chamber.

18. The compressor system of claim 11, wherein guide vanes are positioned within the passage, wherein the damping chamber outlets are connected to the passage upstream from the guide vanes.

19. A method of operating a refrigeration system comprising a compressor, an evaporator, a condenser, and an expansion device, the compressor comprising a housing, a shaft rotatably supported in the housing, an impeller connected to the shaft, and a motor operably connected to the shaft, the method comprising:
compressing a refrigerant using the compressor to produce compressed refrigerant;
condensing the compressed refrigerant using the condenser to produce compressed, condensed refrigerant;
expanding a first portion of the compressed, condensed refrigerant using the expansion device to produce uncompressed, condensed refrigerant;
vaporizing the uncompressed, condensed refrigerant using the evaporator to produce uncompressed, vapor refrigerant;
channeling the uncompressed, vapor refrigerant towards a low pressure line of the compressor;
diverting a second portion of the compressed, condensed refrigerant towards the housing of the compressor to provide cooling to the motor;
channeling the second portion of the compressed, condensed refrigerant towards the low pressure line of the compressor; and
mixing the second portion of the compressed, condensed refrigerant with the uncompressed, vapor refrigerant within the low pressure line of the compressor, wherein mixing the second portion of the compressed, condensed refrigerant and the uncompressed, vapor refrigerant within the low pressure line of the compressor comprises intersecting the uncompressed, vapor refrigerant with the second portion of the compressed, condensed refrigerant at discrete angular flow directions within the low pressure line.

20. The method of claim 19, wherein the housing of the compressor defines at least one coolant flow channel for receiving the second portion of the compressed, condensed refrigerant, and a damping chamber located between the at least one coolant flow channel and the low pressure line of the compressor, wherein intersecting the uncompressed, vapor refrigerant with the second portion of the compressed, condensed refrigerant at the discrete angular flow directions within the low pressure line comprises injecting the second portion of the compressed, condensed refrigerant into the low pressure line at the discrete angular flow directions through outlets of the damping chamber.
